(19) United States
(12) Patent Application Publication
(10) Pub. No.: US 2007/0226319 A1
(43) Pub. Date: Sep. 27, 2007

(54) Interactive wireless broadband network and business support system

(75) Inventor: Brian Christopher Laszakovits, Evergreen, CO (US)

Correspondence Address: FULWIDER PATTON LLP, 200 OCEANGATE, SUITE 1550, LONG BEACH, CA, 90802, US

(73) Assignee: Network Evolution, Inc.

(21) Appl. No.: 11/728,097

(22) Filed: Mar. 23, 2007

Related U.S. Application Data
(60) Provisional application No. 60/784,903, filed on Mar. 23, 2006.

(51) Int. Cl. G06F 15/16

(52) U.S. Cl. 709/218

(57) ABSTRACT

A wireless broadband network employing application specific software components in conjunction with existing hardware elements to permit Internet connectivity, VoIP, communications and other broadband and wireless applications in an automated and integrated environment. The system includes a network-accessible software module accessible by a public network to provide access into and out of the system. The system further comprises a secure database, stateless and stateful software elements to provide access to the database and specific tasks on behalf of the system, a task scheduling routine within the system for monitoring pending actions and reactivating system elements, and a function manager that controls activation of objects and delivery of network and system information based on first-in-first-out sequencing.

### CROSS-REFERENCES TO RELATED APPLICATIONS

This utility application claims priority from U.S. Provisional Patent Application Ser. No. 60/784,903 filed Mar. 23, 2006, the full disclosure of which is fully incorporated herein by reference.

### BACKGROUND OF THE INVENTION

Broadband (high speed) access to the Internet is available from a variety of vendors, including cable providers, DSL providers, satellite providers and wireless providers. Laptops and hand held devices, which are rapidly becoming the tools of choice in the business community, rely predominantly on wireless access to accomplish the goal of mobility. As the capacity and reliability of wireless data transfer expands, wireless broadband Internet access supports a variety of business related applications including web browsing, VoIP telephony and high speed data transmission (downloads and uploads). Accordingly, the demand for wireless Internet access is growing in large cities, rural markets and other communities.

Wireless broadband networks are accomplished and supported using a multitude of hardware, software, and configurations. The various modes of establishing a wireless network leads to a freedom when it comes to instituting a wireless network in a particular area. However, the multitude of options results in the absence of a single preferred configuration or solution for creating, supporting and automating wireless broadband networks. This problem is exacerbated by the inherent complexity involving multiple variables associated with the creation and support of wireless broadband networks. The variables include, for example, the geography of the network, strength of signal, bandwidth required, number of users, need for modalities and capacity to upgrade, and a host of other specifications that determine the proper selection of hardware, software, and coordination between the two.

Traditional approaches to creating wireless broadband networks involve use of “off the shelf” hardware and software to transmit and receive radio signals that connect to the Internet. Installation, operation, and support of these types of networks are generally performed by IT personnel trained to perform these tasks. The present invention is a scalable, automated and integrated network system that combines hardware and software components of wireless broadband networks with additional hardware and proprietary software components, thereby creating an automated system that supports, manages, operates and diagnoses wireless broadband networks.

### SUMMARY OF THE INVENTION

The present invention is a unique wireless broadband network employing application specific software components in conjunction with existing hardware elements to permit Internet connectivity, VoIP, communications and other broadband and wireless applications in an automated and integrated environment. The system in a preferred embodiment includes a multifunction application server adapted to receive, process, and store electronic data operating within the context of wireless and wired Local Area Networks (LAN), Wide Area networks (WAN), Public Switched Telephone Networks (PSTN) and Public Internet. The system further includes a network-accessible software module accessible by a public network to provide access into and out of the system. The system further comprises a secure database, stateless and stateful software elements to provide access to the database and specific tasks on behalf of the system, a task scheduling routine within the system for monitoring pending actions and reactivating system elements, and a function manager that controls activation of objects and delivery of network and system information based on first-in-first-out sequencing.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 illustrates both the physical and logical components of the system of the present invention, including the method in which users connect to the system, and the method in which the system connects to the wireless networks that it supports;

FIG. 2 illustrates the physical and logical components of the system of the present invention where users access the system via a customer service sign-on, and illustrates access rights for the customer service sign-on for those physical and logical components;

FIG. 3 illustrates the physical and logical components of the system of the present invention where users access the system via operations sign-ons, and illustrates access rights for the operations sign-ons for those physical and logical components;

FIG. 4 illustrates the physical and logical components of the system of the present invention where users access the system via a marketing sign-on, and illustrates access rights for the marketing sign-on for those physical and logical components; and

FIG. 5 illustrates the physical and logical components of the system of the present invention where users access the system via the service development sign-on, and illustrates access rights for the service development sign-on for those physical and logical components.

### DETAILED DESCRIPTION OF THE PREFERRED EMBODIMENTS

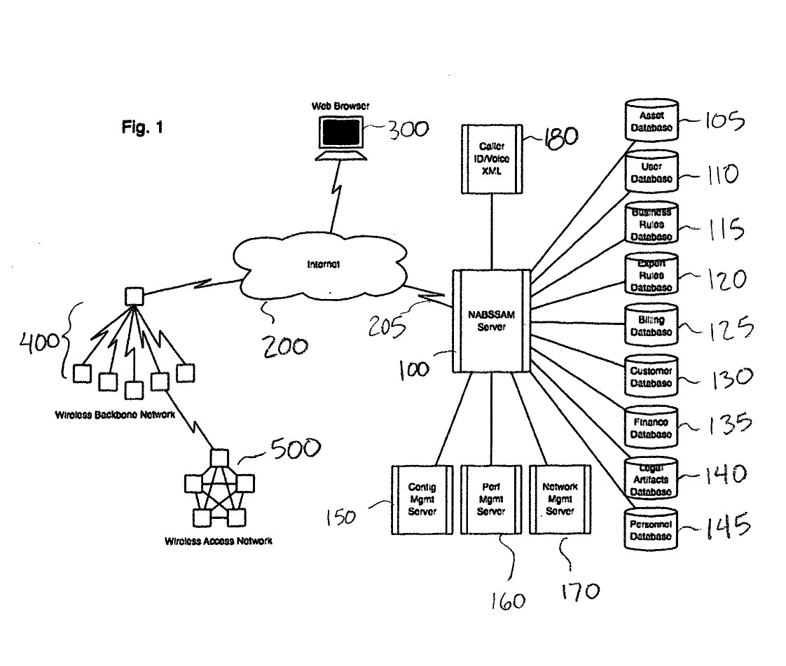

For a better understanding of the present invention together with other and further objects, advantages and capabilities thereof, reference is made to the following disclosure and appended claims in connection with the above described drawings. The present invention is generally characterized as an interactive wireless broadband network and business support system, referred hereinafter as the NABSSAM™ system. FIG. 1 illustrates a first application of the system of the present invention. A primary server 100 is central to the system and is designated the NABSSAM server. The server 100 is capable of receiving, processing, and storing large amounts of electronic data. The server 100 incorporates a logic that governs the processing of user input and network data. The server uses several application languages and protocols in carrying out its operations, including but not limited to the Java™ 2 Platform, Enterprise Edition (J2EE™), Hypertext Transfer Protocol (http), Extensible Markup Language (XML), and vendor proprietary database and system management queries and commands. The server 100 operates within the context of wireless and wired Local Area Networks (LAN), Wide Area networks (WAN), Public Switched Telephone Networks (PSTN) and Public Internet. Inter-application translation methodologies specifically designed to enable communication and information transfer between applications and systems may be interfaced with the server 100 to accommodate a range of standard communication protocols including, but not limited to, simple network management protocol (SNMP), hypertext transfer protocol (HTTP), transmission control protocol (TCP), user datagram protocol (UDP), and internet protocol (IP). The server 100 incorporates a network communication object (NCO), a network accessible software module implemented as JAVA™ Servlet objects that may be visible from a public network and private access into and out of the system of the present invention. The server 100 further includes a messaging mechanism for communication between the components of the system. This mechanism is internal to present system, but is designed such that it may be securely distributed over multiple computer systems, or public or private networks. In the preferred embodiment, data exchange components of the system do not share information that is not “passed” through the messaging mechanism.

The server 100 incorporates a secure database that stores the persistent information for the system of the present invention. Stateless software elements (objects) provide access to the secure database and any other persistent information repositories. In the current embodiment of the invention, these stateless software elements are implemented as Enterprise Javabeans (EJB™) session beans. Stateful software elements (objects) perform specific tasks on behalf of the system upon receipt of pre-specified events. In the current embodiment of the invention these objects are implemented as EJB™ message driven beans.

The system delegates certain functions to services that are available over the public (or private) networks. In the current embodiment of the invention, the system uses the standard industry protocols such as XML, simple object access protocol (SOAP), and J2EE for internal process execution and external communication, as well as voice service. A program within system is activated periodically and serves as a task scheduler that monitors pending actions and reactivates system elements. The system further manages activation of objects and delivery of network and system information based on a first-in-first-out scheme (queues).

Collective operation of the network system involves the following unique functions:
(1) Management and interaction with multiple systems.
(2) Management (enable, disable, change, and monitor) of end-user access to company services.
(3) Monitoring of how end-users use company services.
(4) Monitoring of how company services perform for end-users.
(5) Management (enable, disable, and change) of business process rules that govern billing, marketing, operational, support, and development services; company services access and use; monitoring data use; inventory management; and configuration management.
(6) Management (enable, disable, and change) of expert system decision trees, that control the NABSSAM™ system users' use of the NABSSAM™ system.
(7) Providing customer support services to customers via a remotely connected network computer as if the provider sat presided in a central location within close proximity to the NABSSAM™ system.
(8) Identification of customers who call the company based on their Caller ID, which is provided by an integrated telephone switching system, before answering the incoming call.
(9) Performance of initial connection and performance problem troubleshooting before inquiring as to the nature of an identified customer's incoming telephone call.
(10) Management of (enable, disable, and change) customer information.
(11) Management of (enable, disable, and change) customer billing information.
(12) Scheduling of customer appointments for company customer technology service partners.
(13) Management of (add, delete, and modify) the company's legal artifact library.
(14) Management of (add, delete, and modify) the company's personnel artifact library.
(15) Management of (add, delete, and modify) the company's financial bookkeeping records.
(16) Administration and maintenance of the NABSSAM™ system.
(17) Management of (add, delete, modify, and offer) the company's marketing promotions to customers.
(18) Management and integration of new software and hardware components into the NABSSAM™ system.
(19) Management of (add, delete, and change) asset inventory.
(20) Management of (add, delete, and change) the configuration of network and system components.

FIG. 1 illustrates the various modules that are accessed by the server 100. The asset database 105 is a separate database for storing the assets of the network provider. The user database 110 is another database to store information on the users of the network. The business rules database 115 maintains information on the network's business rules. The expert rules database 120 stores instruction pertaining to the expert rules. The billing database 125 is a repository for the information concerning customer billing, and the customer database 130 stores customer identification data as well as other customer related information. The finance 135, legal artifact 140, and personnel database 145 are also accessed by the server 100.

The main server 100 is supported by three secondary servers, namely the configuration management server 150, the performance management server 160, and the network management server 170. The server is also coupled to a caller ID, voice Extensible Markup Language (XML) module 180 for performing the caller identification function and communicating the information to the server 100. The server 100 is connected to the internet 200 through a device located in a dedicated computer system environment via a standard connection such as an Ethernet (802.11) connection, for example. The internet is, in turn, linked to a remote web browser 300 and a wireless backbone network 400. The wireless backbone network 400 in turn is connected to a wireless access network 500.

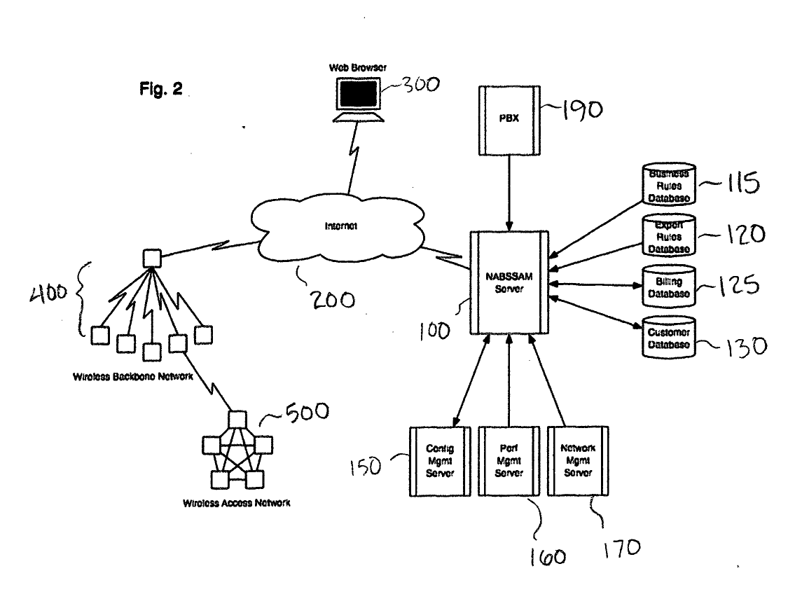

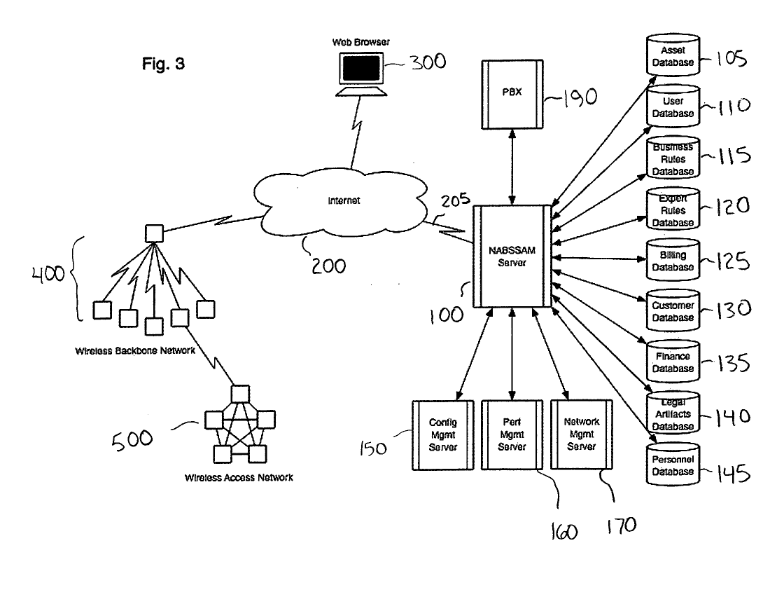

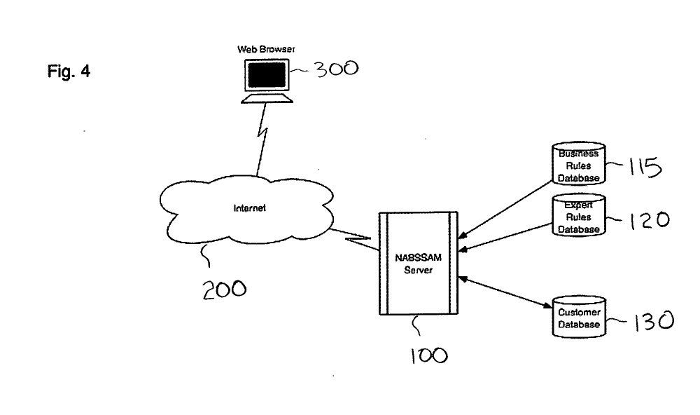

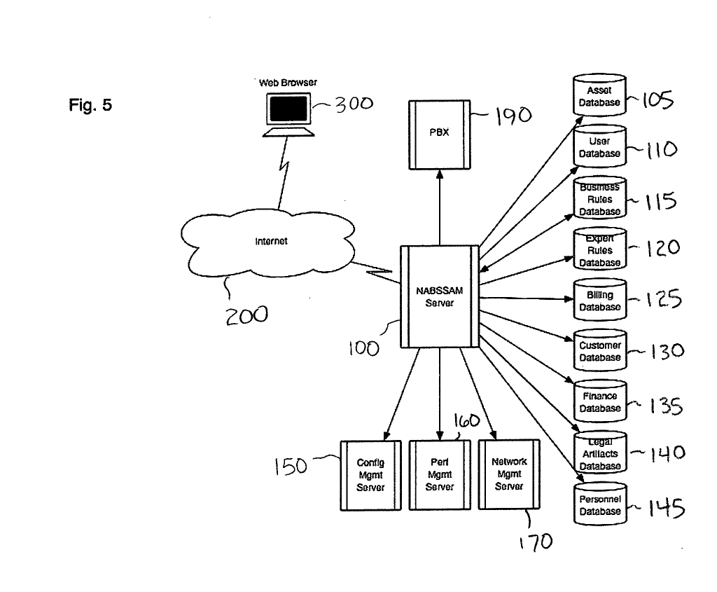

In FIG. 2, where like reference numbers represent like elements, the server 100 is incorporated into a customer support application having a reduced number of database modules (business rules 115, expert rules 120, billing 125, and customer 130). The caller ID module 180 has been replaced in the second embodiment by a private branch exchange, or PBX, module 190. The PBX module 190 corresponds to a private telephone network that enables calls external to the PBX module 190. The PBX module of FIG. 2 is incorporated into the Business Support System of FIG. 1 to achieve the Operations embodiment of FIG. 3. In FIG. 5, the Service Development embodiment eliminates the wireless backbone network 400 and the wireless access network 500 from the Operations embodiment of FIG. 3. Finally, the embodiment of FIG. 4 comprises the server 100, the internet connection to the remote web browser 300, and the business rules 115, expert rules 120, and customer databases 130.

I claim:

1. An interactive wireless broadband network and business support system comprising:
a multifunctional primary server capable of interfacing with inter-application translation methodologies to enable communication and information transfer between user selected applications and user designated systems, said primary server further accommodating a plurality of standard communication protocols;
a caller ID module connected to the primary server to determine an identification of a caller communicating with the primary server;
a configuration management server in communication with and supporting the primary server, said configuration management server storing rules for establishing and maintaining said network;
a performance management server in communication with and supporting said primary server, said performance management server monitoring an operation and performance of said network and identifying problems in said network;
a network management server in communication with and supporting said primary server, said network management server controlling the operation of the network according to predetermined rules stored in said network management server;
a business rules database accessible by said primary server;
an expert rules database accessible by said primary server;
a customer database; and
a wireless internet connection means for connecting wirelessly to the internet, a remote web browser, and a wireless backbone network.

2. The interactive wireless broadband network and business support system of claim 1 further comprising a plurality of additional databases accessible by said primary server selected from the group of: an asset database, a user database, a billing database, a finance database, a legal artifact database, and a personnel database.

3. The interactive wireless broadband network and business support system of claim 1 further comprising a plurality of additional databases accessible by said primary server including an asset database, a user database, a billing database, a finance database, a legal artifact database, and a personnel database.

4. An interactive wireless broadband network and business support system comprising:
a multifunctional primary server capable of interfacing with inter-application translation methodologies to enable communication and information transfer between user selected applications and user designated systems, said primary server further accommodating a plurality of standard communication protocols;
a private branch exchange (PBX) module in communication with said primary server for distributing incoming and outgoing telephone calls from the system;
a configuration management server in communication with and supporting the primary server, said configuration management server storing rules for establishing and maintaining said network;
a performance management server in communication with and supporting said primary server, said performance management server monitoring an operation and performance of said network and identifying problems in said network;
a network management server in communication with and supporting said primary server, said network management server controlling the operation of the network according to predetermined rules stored in said network management server;
a business rules database accessible by said primary server;
an expert rules database accessible by said primary server;
a customer database; and
a wireless internet connection means for connecting wirelessly to the internet, a remote web browser, and a wireless backbone network.

5. The interactive wireless broadband network and business support system of claim 4 further comprising a plurality of additional databases accessible by said primary server selected from the group of: an asset database, a user database, a billing database, a finance database, a legal artifact database, and a personnel database.

6. The interactive wireless broadband network and business support system of claim 4 further comprising a plurality of additional databases accessible by said primary server including an asset database, a user database, a billing database, a finance database, a legal artifact database, and a personnel database.

7. The interactive wireless broadband system of claim 1 further comprising an automated single sign-on interface accessible from a remote web browser, wherein access rights of said sign-on is governed by said business rules database to determine system functions to be displayed in a sign-on user's web browser, and wherein a user is then authenticated to use all system functions enabled by the access rights provided at sign-on for the duration of the sign-on session.

8. The interactive wireless broadband system of claim 1 further comprising means to allow the system to permit customers automated access to said customer's billing and service information via a billing database connected to said primary server.

9. The interactive wireless broadband system of claim 1 further comprising means for allowing a customer service representative automated access to a customer's service and billing information, customer's login status, customer's current performance statistics, and customer's current use of the network, wherein the information displayed to said customer service representative is governed by said business rules and by said expert system databases.

10. The interactive wireless broadband system of claim 1 further comprising means for automatically terminating a sign-on session if no user activity is detected after a configurable time-out period is reached.

11. The interactive wireless broadband system of claim 1 further comprising a software application configured for facilitating network component connectivity and operational information.

12. The interactive wireless broadband system of claim 1 further comprising a software application configured for collecting and reporting network component performance information.

13. The interactive wireless broadband system of claim 1 further comprising a software application configured for tracking all company assets in a proprietary database.

14. The interactive wireless broadband system of claim 1 further comprising an integrated an end-user authentication system including a software application to provide secure access to company IT assets and network access services.

15. The interactive wireless broadband system of claim 1 further comprising an integrated business rules system comprising software that accesses said business rules database to determine user access rights, and direct input, use and management of data.

16. The interactive wireless broadband system of claim 1 further comprising a telephone call switching system (PBX) comprised of a software application providing inbound caller ID information and call routing.

17. The interactive wireless broadband system of claim 1 further comprising a billing system comprised of a software application used for customer billing and notification of billing events.

18. The interactive wireless broadband system of claim 1 further comprising a customer information database and software for storing and managing customer information.

19. The interactive wireless broadband system of claim 1 further comprising a consumer technology service scheduler comprising a software application used to schedule and coordinate service appointments held by customers with company technology service partners.

20. The interactive wireless broadband system of claim 1 further comprising a customer support interface comprising a web site used by a company customer support representative to provide customer service to customers, said web site providing access only to customer service functions and interacting with other system components to troubleshoot customer connectivity and performance issues, add services to the customer profile, schedule service appointments for a customer with company technology service providers, and to manage customer information.

21. The interactive wireless broadband system of claim 1 further comprising a web site used by company operations personnel to manage legal, financial, HR, and other company functions, said web site providing access only to operational functions as determined by the sign-on access rights of an end-user.

22. The interactive wireless broadband system of claim 1 further comprising a marketing interface comprising of a web site used by company marketing personnel to manage company marketing functions, said web site providing access only to marketing functions as determined by the sign-on access rights of the end-user.

23. The interactive wireless broadband system of claim 1 further comprising a service development interface comprising a web site used by company IT development personnel to manage development projects, and to upgrade and maintain the system's software, said web site providing access only to development and administrative functions as determined by the sign-on access rights of an end-user.

24. The interactive wireless broadband system of claim 1 further comprising a financial accounting system comprising of a software application used for accounting functions including a management of accounts receivable, accounts payable, and payroll information.

25. The interactive wireless broadband system of claim 1 further comprising a legal artifacts system comprising a software application used to manage legal artifacts including contracts and agreements.

26. The interactive wireless broadband system of claim 1 further comprising a personnel artifacts system comprising a software application used to manage legal artifacts related to company personnel.

27. The interactive wireless broadband system of claim 1 further comprising means to manage company networks that customers use to access the Internet, said company networks being comprised of wireless network nodes that provide direct connectivity to network access services provided by the company, and wherein said wireless network nodes connect together wirelessly, and connect to a wireless back haul network, which in turn connects to a dedicated Internet access point.
